(19) United States
(12) Patent Application Publication
(10) Pub. No.: US 2012/0254233 A1
(43) Pub. Date: Oct. 4, 2012

(54) INFORMATION PROCESSING SYSTEM, INFORMATION PROCESSOR, AND COMPUTER PROGRAM PRODUCT

(75) Inventor: Natsuki Nose, Saitama (JP)

(73) Assignee: KABUSHIKI KAISHA TOSHIBA, Tokyo (JP)

(21) Appl. No.: 13/406,993

(22) Filed: Feb. 28, 2012

(30) Foreign Application Priority Data
Mar. 31, 2011 (JP) 2011-078366

(51) Int. Cl. G06F 17/30

(52) U.S. Cl. 707/769; 707/E17.014

(57) ABSTRACT

According to one embodiment, an information processing system includes: a storage module; an extractor; a notifying module; and a search module. The storage module is configured to store therein content. The extractor is configured to extract a plurality of keywords acquired from the storage module, the keywords being related to content in use by a user. The notifying module is configured to notify the user of the keywords extracted by the extractor. The search module is configured to add the keywords extracted by the extractor to a selected keyword selected by the user from among the keywords notified by the notifying module, and to carry out a search of content based on the keywords.

### CROSS-REFERENCE TO RELATED APPLICATIONS

This application is based upon and claims the benefit of priority from Japanese Patent Application No. 2011-078366, filed Mar. 31, 2011, the entire contents of which are incorporated herein by reference.

### FIELD

Embodiments described herein relate generally to an information processing system, an information processor, and a computer program product.

### BACKGROUND

Conventionally, there is known an information search system for searching information based on a user-selected keyword.

However, conventional information search systems may output a wide search result in a range not intended by a user. Therefore, a user-friendly information search method has been desired.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating a configuration of an information processing system comprising an information processor according to a first embodiment;

FIG. 2 is an exemplary block diagram of a hardware configuration of a control system of the information processor in the first embodiment;

FIG. 3 is an exemplary block diagram of a functional configuration of the information processor in the first embodiment;

FIG. 4 is an exemplary schematic diagram illustrating a configuration of a web page displayed on a display device by a content display module in the first embodiment;

FIG. 5 is an exemplary schematic diagram of a configuration of a keyword display screen in the first embodiment;

FIG. 6 is an exemplary schematic diagram of a configuration of a browsing history display screen in the first embodiment;

FIG. 7 is an exemplary flowchart of processes of the information processor in the first embodiment;

FIG. 8 is another exemplary flowchart of processes of the information processor in the embodiment;

FIG. 9 is an exemplary block diagram of a functional configuration of an information processor according to a second embodiment;

FIG. 10 is an exemplary schematic diagram of a configuration of a browsing history display screen in the second embodiment; and

FIG. 11 is an exemplary schematic diagram of a configuration of a browsing history display screen in the second embodiment.

### DETAILED DESCRIPTION

In general, according to one embodiment, an information processing system comprises: a storage module; an extractor; a notifying module; and a search module. The storage module is configured to store therein content. The extractor is configured to extract a plurality of keywords acquired from the storage module, the keywords being related to content in use by a user. The notifying module is configured to notify the user of the keywords extracted by the extractor. The search module is configured to add the keywords extracted by the extractor to a selected keyword selected by the user from among the keywords notified by the notifying module, and to carry out a search of content based on the keywords.

Various embodiments will be described hereinafter with reference to the accompanying drawings.

An instance of applying an information processor according to a first embodiment to a personal computer (PC) used by a user will be explained.

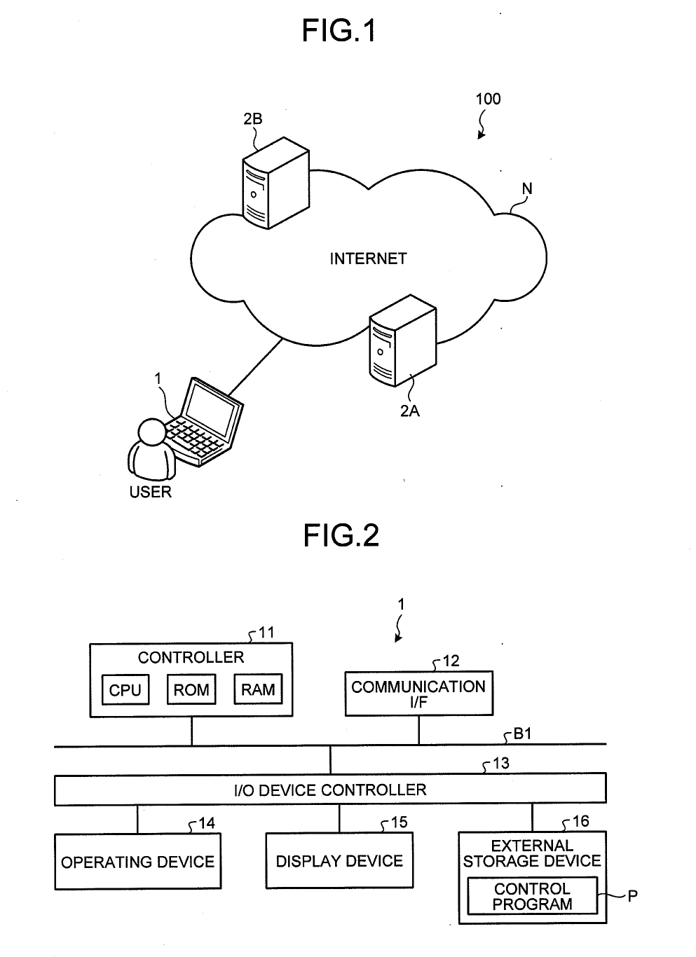

FIG. 1 is a diagram illustrating a schematic configuration of an information processing system 100 comprising an information processor 1 according to the first embodiment.

As illustrated in FIG. 1, in the information processing system 100, the information processor 1 configured with a personal computer (PC) and the like used by a user is communicably connected to the Internet N (including a server 2A for providing content, a server 2B for searching keyword, and such which will be described later).

The server 2A here is a device that provides content (information for displaying a web page) to the information processor 1, and is a device that provides the content stored in a storage device (storage unit, for example, a hard disk drive (HDD) and a solid state drive (SSD)) mounted on the own device or a storage device (storage unit) connected to the own device.

The server 2B is a device that carries out a search of content (web page) based on a search formula by a later described combination of keywords.

FIG. 2 is a block diagram illustrating a hardware configuration of a control system of the information processor 1 according to the first embodiment.

As depicted in FIG. 2, the information processor 1 has a hardware configuration using a general computer such as a personal computer, and is configured with, for example, a controller 11, a communication I/F 12, and an I/O device controller 13 connected with one another via a bus B1.

The controller 11 is configured to comprise a central processing unit (CPU), a read only memory (ROM), a random access memory (RAM), and the like.

The controller 11 is further connected with an operating device (e.g., a keyboard, a mouse) 14, a display device (for example, a liquid crystal display) 15, an external storage device (for example, an HDD and an SSD) 16, and the like via the bus B1 and the I/O device controller 13.

More specifically, the controller 11 controls, by the CPU loading a control program stored in the ROM or the external storage device 16 into the RAM and executing it, the operations of various devices connected via the I/O device controller 13 and the operations of sending and receiving various types of data between various servers connected via the communication I/F 12 and the Internet N.

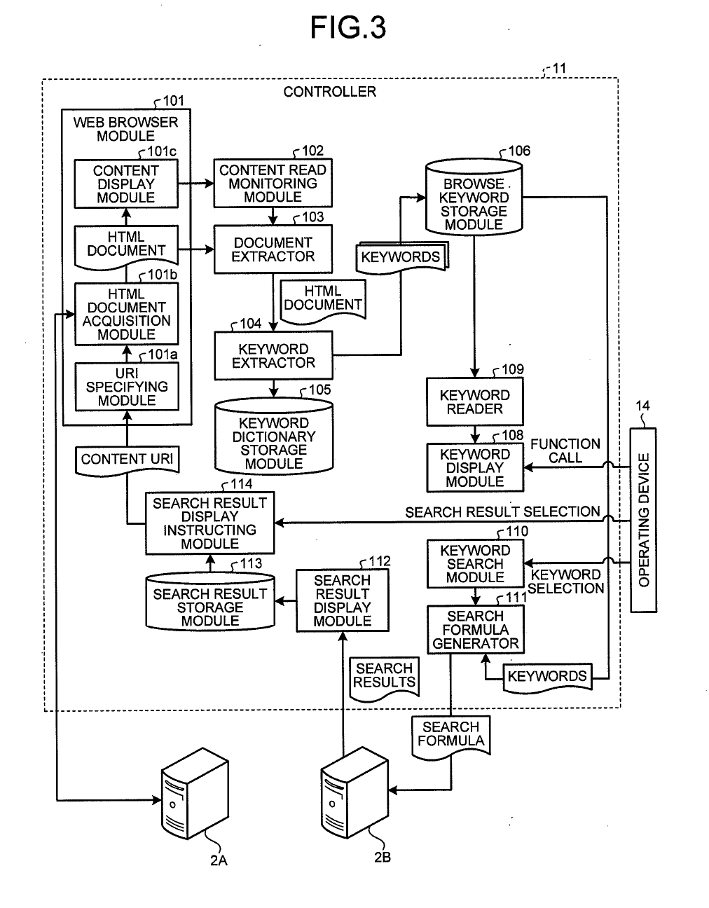

In the present embodiment, the external storage device 16 stores therein control programs P (including later described resident programs and plug-ins) to realize a functional configuration illustrated in FIG. 3 which will be described later.

Although not specifically depicted in FIG. 2, the information processor 1 is mounted with a speaker and such to output various types of sound such as a warning sound, and is operational with a required power supplied from, for example, a commercial power source, a rechargeable battery, or the like through a power supply module not depicted.

FIG. 3 is a block diagram illustrating the functional configuration of the information processor 1 according to the first embodiment.

As illustrated in FIG. 3, the controller 11 of the information processor 1 functions, by the CPU loading a predetermined control program P stored in the external storage device 16 or the like into the RAM and executing it, as a web browser module 101, a content read monitoring module 102, a document extractor 103, a keyword extractor 104, a keyword dictionary storage module 105, a browse keyword storage module 106, a keyword display module 108, a keyword reader 109, a keyword search module 110, a search formula generator 111, a search result display module 112, a search result storage module 113, and a search result display instructing module 114 by which a processing procedure in a later mentioned flowchart is executed.

The web browser module 101 carries out the process of browsing web pages on the Internet N, and comprises, for example, a uniform resource identifier (URI) specifying module 101a, a hypertext markup language (HTML) document acquisition module 101b, and a content display module 101c.

The URI specifying module 101a receives an URI specifying a web page a user desires to view, when the user enters the URI of an access destination in an address bar (field) of the web browser and presses a return key or clicks on a hypertext link in the browsing web page with a mouse.

The HTML document acquisition module 101b sends, based on the URI received by the URI specifying module 101a, a hypertext transfer protocol (HTTP) request by which sending back data (HTML document) concerning the web page specified by the URI is requested to the server 2A, and receives an HTTP response returned as a result of search performed by the server 2A. In other words, the HTML document acquisition module 101b acquires data (HTML document) concerning the web page specified by the URI.

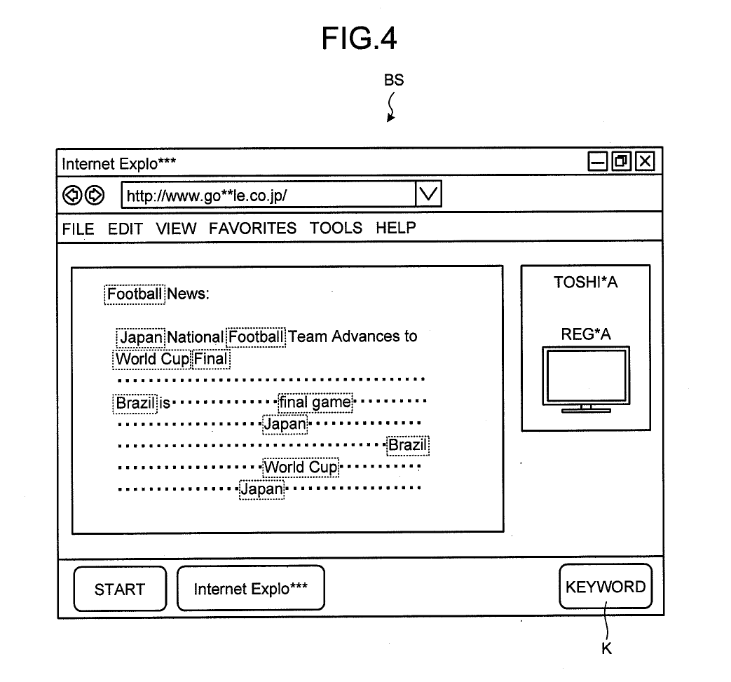

The content display module 101c analyzes data acquired in the HTML document acquisition module 101b, and carries out the process of displaying the web page (see FIG. 4) on the display device 15.

FIG. 4 is a schematic diagram illustrating an example of a configuration of the web page displayed on the display device 15 by the content display module 101c. The example in FIG. 4 illustrates a desktop screen on which a web browser screen BS is displayed. Here, the web browser screen BS displays a web page on which an advertisement and sentences of “Football News: Japan National Football Team Advances to World Cup Final . . . Brazil is . . . final game . . . Japan . . . Brazil . . . World Cup . . . Japan . . . ” are displayed.

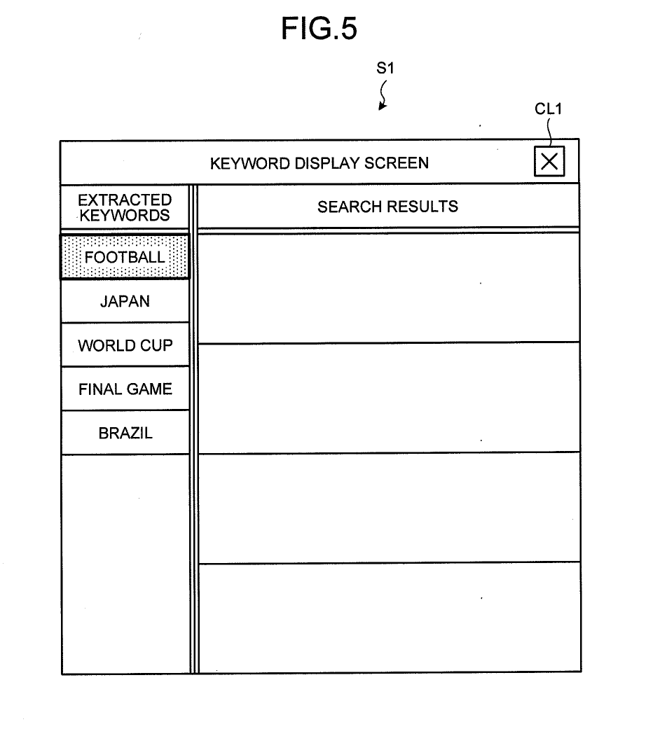

On the desktop screen depicted in FIG. 4, in a task tray at a region on the right hand side of a taskbar, a dedicated icon K is displayed indicating that a processing program as a resident program that executes the process of displaying a later described keyword display screen (see FIG. 5) is in operation.

Referring back to FIG. 3, when the content read monitoring module 102 recognizes that the content display module 101c has completed reading an HTML document from the HTML document acquisition module 101b, i.e., the content display module 101c has completed displaying the web page, the content read monitoring module 102 outputs a completion notice to the document extractor 103.

The document extractor 103 carries out the process of acquiring an HTML document extracted from an entity body (message body) of an HTTP response by the analysis performed by the content display module 101c, and outputs it to the keyword extractor 104.

A plug-in of the web browser may be used, for example, to realize the content read monitoring module 102 which recognizes that the content display module 101c has completed reading an HTML document. Similarly, a plug-in of the web browser may be used to realize the document extractor 103 which extracts an HTML document.

The keyword extractor 104 carries out morphological analysis of an HTML document received from the document extractor 103. Then, the keyword extractor 104 refers to information preliminarily stored in the keyword dictionary storage module 105. Subsequently, the keyword extractor 104 extracts, from a plurality of morphemes thus analyzed, distinguishing keywords necessary to search web pages (content) similar to the web page currently browsed by the user, i.e., the web page (content) which has been displayed by the content display module 101c.

When the extraction of the keywords is completed, the keyword extractor 104 updates keywords stored in the browse keyword storage module 106.

The keyword dictionary storage module 105 stores therein, as the information for extracting the distinguishing keywords, for example, information indicative of an appearance frequency threshold for extracting frequently appeared morphemes (for example, appearance frequency of twice) as distinguishing keywords.

The browse keyword storage module 106 stores therein the distinguishing keywords extracted by the keyword extractor 104 from the web page (content) currently browsed by the user, i.e., from the HTML document of the web page (content) which has been displayed by the content display module 101c.

The keyword display module 108 gives instructions to the keyword reader 109 to read keywords when the user carries out a given keyword function calling operation (for example, a selection operation of the dedicated icon K depicted in FIG. 4) with the operating device 14, and carries out the process of making the display device 15 display the keywords acquired from the reply to the instructions in a user recognizable form.

Specifically, the keyword display module 108 displays a keyword display screen S1 as illustrated in FIG. 5 in a pop-up on a web browser screen BS illustrated in FIG. 4.

FIG. 5 is a schematic diagram illustrating an example of a configuration of the keyword display screen S1. As illustrated in FIG. 5, the keyword display screen S1 displays keywords that the keyword reader 109 has read out, as a list. The example in FIG. 5 illustrates a situation where “Football”, “Japan”, “World Cup”, “Final game”, “Brazil”, and such are displayed as extracted keywords in the fields at the left hand side of the figure.

Returning to FIG. 3, the keyword reader 109 reads out keywords stored in the browse keyword storage module 106 in response to instructions given from the keyword display module 108.

The keyword search module 110 receives a keyword selected by the user (hereinafter, also simply referred to as a selected keyword) with the operating device 14 (more specifically, any one of the keywords selected from the keywords displayed on a keyword display screen S1 depicted in FIG. 5), and outputs it to the search formula generator 111.

The search formula generator 111 acquires, when the selected keyword is obtained from the keyword search module 110, the keywords stored in the browse keyword storage module 106, generates a search formula based on the acquired keywords, and then carries out a web search (more specifically, search for URIs of web pages (content) searched by the search formula) by the server 2B that is reachable via an IP network.

An example of generating a specific search formula by the search formula generator 111 will be explained. For example, assuming that the selected keyword selected by the user is a keyword 1 and keywords acquired from the browse keyword storage module 106 are a keyword 2 and a keyword 3, the search formula generator 111 generates a search formula as (keyword 1 AND keyword 2) OR (keyword 1 AND keyword 3).

The search result display module 112 displays search results (hypertext links) searched by the search formula generated by the search formula generator 111, and stores the search results (e.g., URIs of link destinations) in the search result storage module 113.

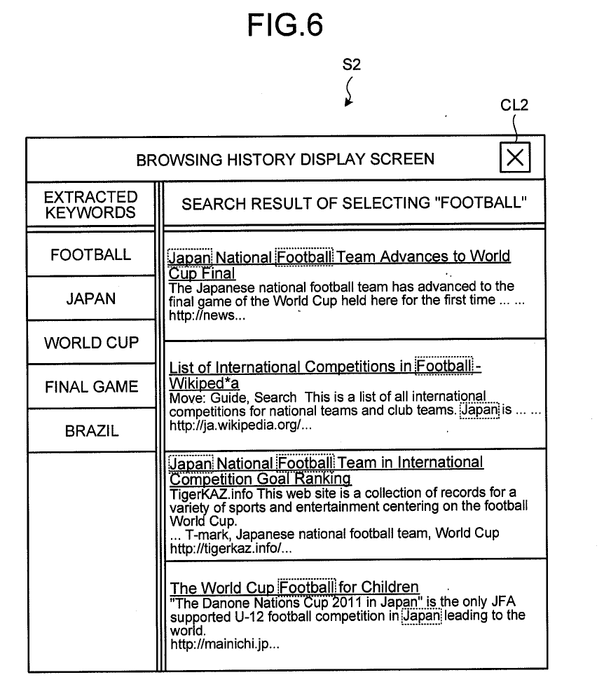

Specifically, the search result display module 112 causes the display device 15 to display a browsing history display screen S2 as illustrated in FIG. 6.

FIG. 6 is a schematic diagram illustrating an example of a configuration of a browsing history display screen S2. As illustrated in FIG. 6, the browsing history display screen S2 displays search results searched by the server 2B (e.g., hypertext links, text briefly explaining the content of web pages of link destinations, URIs) in the fields on the right side of the keyword display screen S1, as a list. The example in FIG. 6 illustrates search results of when the keyword “Football” is selected by the user on the keyword display screen S1 depicted in FIG. 5, or in other word, illustrates the search results based on the search formula of (keyword 1: Football AND keyword 2: Japan). Furthermore, the example in FIG. 6 illustrates the underlined text as hypertext links, i.e., the underlined text of “Japan National Football Team Advances to World Cup Final”, “List of International Competitions in Football—Wikiped*a”, “Japan National Football Team in International Competition Goal Ranking”, and “The World Cup for Children” are illustrated as the hypertext links.

Referring back to FIG. 3, the search result storage module 113 stores therein search results (e.g., URIs of web pages (content)) searched using the search formula generated by the search formula generator 111.

The search result display instructing module 114 reads out a URI of the search result (link destination) selected by the user from the search result storage module 113 when any of the search results, i.e., hypertext link, is clicked by the user on the browsing history display screen S2 illustrated in FIG. 6 displayed by the search result display module 112, and then gives instructions to the web browser module 101 to make the display device 15 display the web page of the URI thus read out.

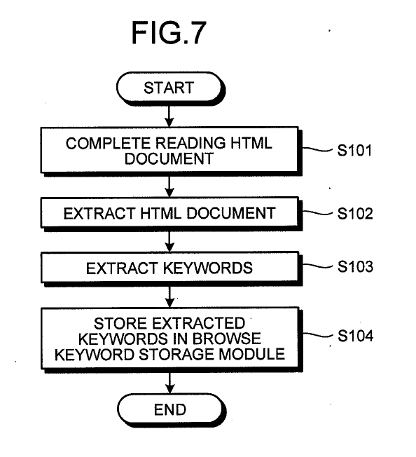

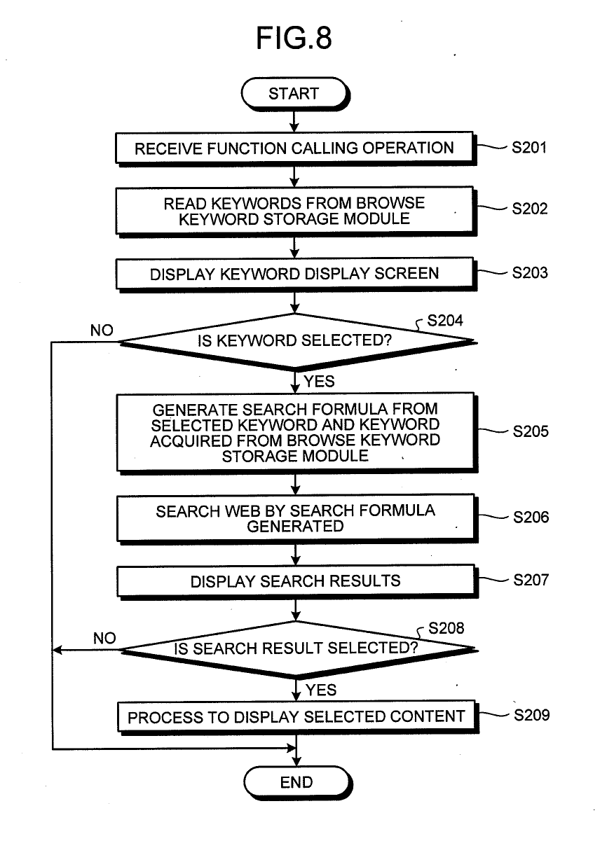

The details of process operation in the information processor 1 thus configured will be described with reference to FIGS. 7 and 8.

FIG. 7 is a flowchart of process of the information processor 1, and in this case, in particular, a processing procedure is illustrated from extracting distinguishing keywords from a web page (content) that the user is browsing (in use) up to storing them.

As illustrated in FIG. 7, in the process, when the content read monitoring module 102 first recognizes that the content display module 101c has completed reading an HTML document, i.e., displaying a web page is completed (S101), the document extractor 103 acquires the HTML document from the content display module 101c and sends it to the keyword extractor 104 (S102).

Subsequently, the keyword extractor 104 extracts distinguishing keywords from the HTML document received from the document extractor 103 by the above-described extracting method (S103), and causes the browse keyword storage module 106 to store therein the extracted keywords (S104).

An example of a specific process in the above-described processing procedure illustrated in FIG. 7 will be described.

For example, a situation of extracting keywords while the user is browsing (in use) the web page (content) illustrated in FIG. 4 will be explained.

In this case, at S101, when the completion of reading an HTML document for displaying the web page illustrated in FIG. 4 is recognized, i.e., when the completion of displaying the web page illustrated in FIG. 4 is recognized, the document extractor 103 acquires, at S102, the HTML document for displaying the web page illustrated in FIG. 4, and outputs it to the keyword extractor 104.

At S103, the keyword extractor 104 extracts “Football”, “Japan”, “World Cup”, “Final game”, and “Brazil” as the distinguishing keywords from the HTML document received from the document extractor 103 based on the appearance frequency threshold (for example, twice) stored in the keyword dictionary storage module 105, and at S104, stores them in the browse keyword storage module 106.

FIG. 8 is a flowchart of process of the information processor 1, and particularly illustrates a processing of calling out the present function and displaying a keyword display screen S1 and a browsing history display screen S2.

As illustrated in FIG. 8, in the process, when a given keyword function calling operation (selection operation of the dedicated icon K) is performed by the user (S201), the keyword reader 109 reads out the keywords stored in the browse keyword storage module 106 (S202). The keyword display module 108 then causes the display device 15 to display a keyword display screen S1 displaying the keywords read out at S202 (S203).

Thereafter, it is determined whether a keyword is selected or whether a close-button icon (x) CL1 is selected by the user (S204). As a result, when no keyword is selected but the close-button icon CL1 is selected by the user (No at S204), the keyword display screen S1 is closed and the process here is terminated.

On the other hand, when any one of the keywords is selected by the user with a mouse and such (Yes at S204), the keyword search module 110 outputs the keyword selected by the user to the search formula generator 111. Accordingly, the search formula generator 111 generates a search formula based on the keyword acquired from the keyword search module 110 (more specifically, the keyword selected by the user) and keywords acquired from the browse keyword storage module 106 (S205), and carries out a web search by the server 2B reachable via an IP network (S206).

The search result display module 112 then displays, as illustrated in FIG. 6, the result of the search at S206 as the browsing history display screen S2 (S207).

Thereafter, it is determined whether the search result is selected or whether a close-button icon (x) CL2 is selected by the user (S208). As a result, when no search result is selected but the close-button icon CL2 is selected by the user (No at S208), the browsing history display screen S2 is closed and the process here is terminated.

In contrast, when any one of the search results (i.e., a hypertext link) is selected by the user with a mouse and such (Yes at S208), the search result display instructing module 114 reads out the URI corresponding to the selected search result (link destination) from the search result storage module 113, and gives instructions to the web browser module 101 to display the web page corresponding to the URI. Consequently, the web page corresponding to the search result selected by the user is displayed on the display device 15 in a display condition illustrated in FIG. 4 by the web browser module 101 (S209).

An example of a specific process in the above-described processing procedure illustrated in FIG. 8 will be described.

For example, a situation of the user selecting the keyword “football” on a keyword display screen while the keywords of “Football”, “Japan”, “World Cup”, “Final game”, and “Brazil” are stored in the browse keyword storage module 106 will be explained.

In this case, at S202, the keywords of “Football”, “Japan”, “World Cup”, “final game”, and “Brazil” are readout from the browse keyword storage module 106, and at S203, the keyword display screen S1 as illustrated in FIG. 5 is displayed. More specifically, “Football”, “Japan”, “World Cup”, “Final game”, and “Brazil” are displayed as the extracted keywords.

On the keyword display screen S1, when the keyword “Football” is selected by the user with a mouse and such (Yes at S204), the keyword search module 110 outputs, at S205, the selected keyword “Football” selected by the user to the search formula generator 111, and the search formula generator 111 generates a search formula (Football AND Japan) based on the keyword (Football) acquired from the keyword search module 110 and a distinguishing (major) keyword other than the user-selected keyword (for example, “Japan” as the most frequently appeared keyword) out of the keywords acquired from the browse keyword storage module 106 (keywords acquired from the content being browsed). The major keyword is not restricted to the most frequently appeared keyword, and it can be defined as a keyword appearing close to the selected keyword (immediately before or after it), or the first appearing keyword in the content, for example.

At S206, a web search is carried out by the search formula (Football AND Japan) generated at S205 to search web pages (content) that include “Football” and “Japan”.

As a consequence, at S207, the browsing history display screen S2 (see FIG. 6) displaying the search results including link destinations (hypertext links) of web pages (content) that include “Football” and “Japan” is on the display device 15.

A second embodiment will be described.

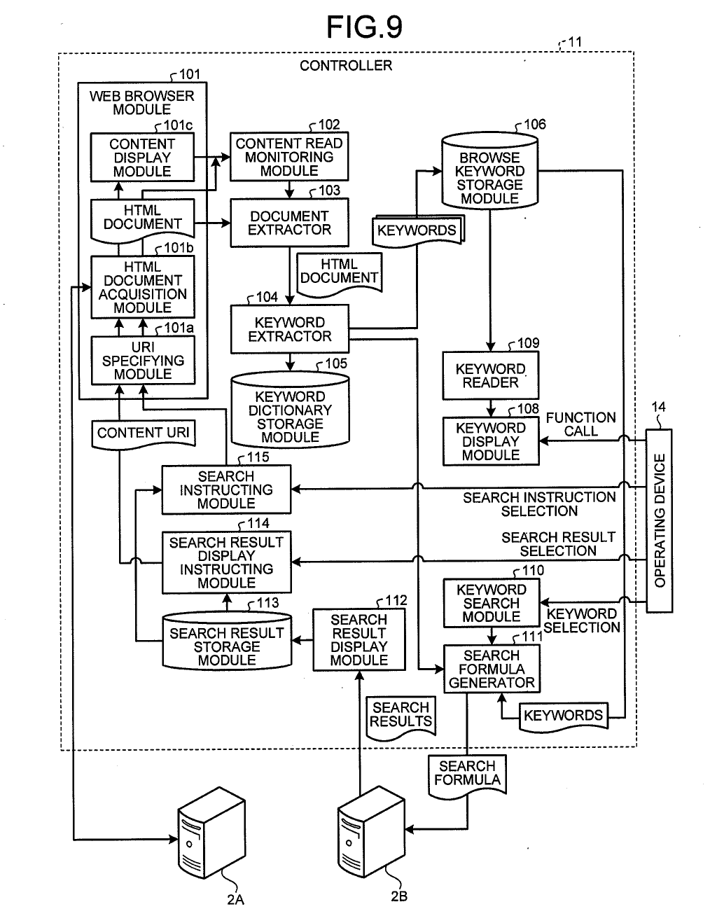

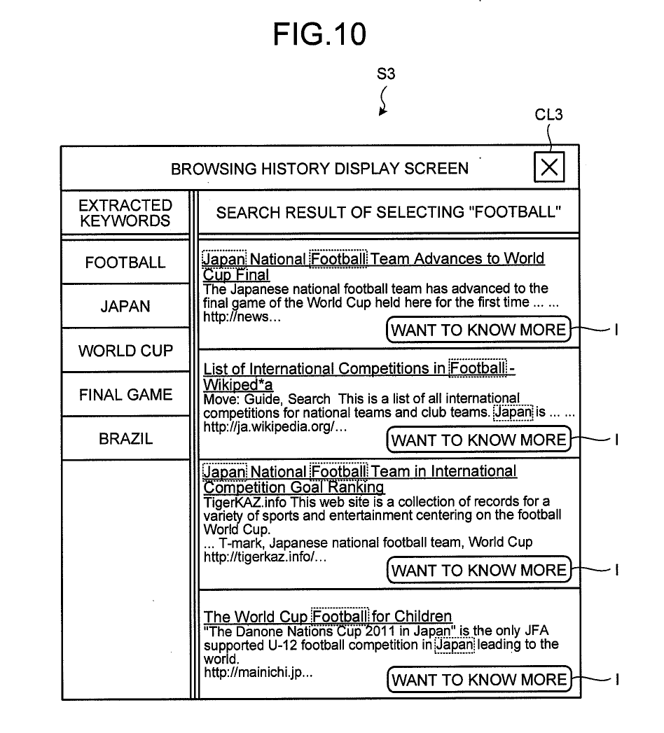

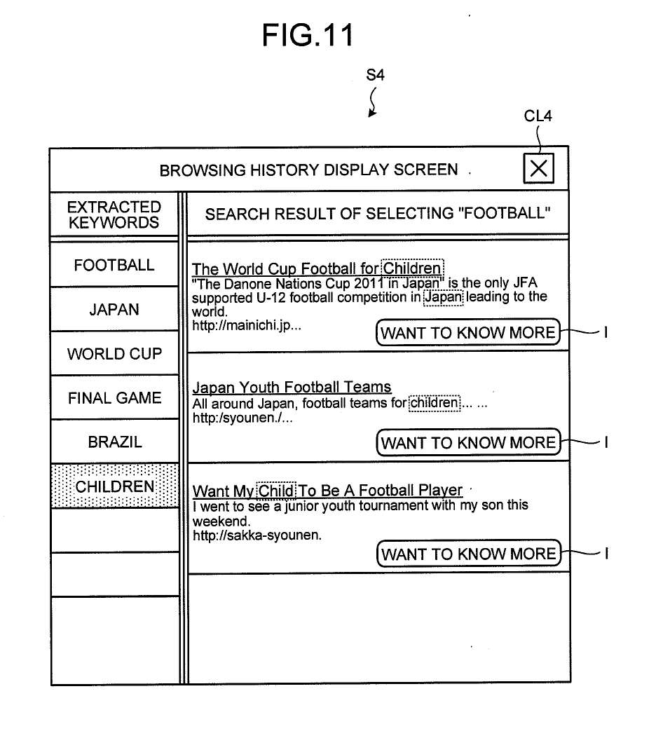

FIG. 9 is a block diagram illustrating a functional configuration of an information processor according to the second embodiment, and FIGS. 10 and 11 are schematic diagrams illustrating examples of the configuration of browsing history display screens S3 and S4 in the second embodiment.

In FIG. 9, it is configured that a search instructing module 115 is newly added to the functional configuration depicted in FIG. 3 explained in the first embodiment, and other configurations are the same. Thus, the explanation for the functions of the same reference symbols is omitted in the following description.

In FIGS. 10 and 11, a user selectable select-button icon (“WANT TO KNOW MORE”) I is added for each of the search results listed on the browsing history display screens S3 and S4.

More specifically, in the second embodiment, when the user selects a select-button icon (“WANT TO KNOW MORE”) I available for each of the search results listed on the browsing history display screen S3, the search instructing module 115 acquires a corresponding search result (URI) from the search result storage module 113 and gives instructions to the web browser module 101 to acquire an HTML document.

However, in this case, displaying of content by the content display module 101c is not performed, but the keyword extractor 104 extracts distinguishing keywords from the HTML document. Subsequently, in addition to the search formula used to create the list of search results displayed at that point in a list form on the right side of the browsing history display screen S3, the distinguishing keywords thus extracted are added to generate a new search formula. A web search is then carried out by the server 2B reachable via an IP network and the search results displayed on the right side of the browsing history display screen S3 are updated to display search results (browsing history display screen S4).

An example of a specific process of the second embodiment will be explained with reference to FIGS. 10 and 11.

The following explanation is provided for the case when the browsing history display screen S3 illustrated in FIG. 10 is displayed, the select-button icon (“WANT TO KNOW MORE”) I included in the display of the search result at the lowermost portion of the search results (the search result displayed with a hypertext link of “The World Cup for Children”) is selected, and when the keyword extracted from the web page (content) specified by the search result (URI) is “Children”.

When the select-button icon I in the search result of the lowermost portion on the browsing history display screen S3 in FIG. 10 is selected by the user, the search instructing module 115 acquires a corresponding search result (URI http//mainichi.jp . . . ) from the search result storage module 113, and gives instructions to the web browser module 101 to acquire an HTML document. The keyword extractor 104 then extracts the word “Children” as a distinguishing keyword from the HTML document.

Then, the extracted distinguishing keyword (for example, “Children”) is added to the search formula (for example, “Football” AND “Japan”) used to create the list of search results displayed at that point in a list form on the right side of the browsing history display screen S3 to generate a search formula (for example, “Football” AND “Japan” AND “Children”), and a web search is executed by the generated search formula. The list of search results on the right side of the browsing history display screen S3 is then updated with the search results of the present search and is displayed as a browsing history display screen S4.

In other words, in accordance with the respective embodiments, a user friendly information search method can be provided.

More specifically, in the conventional art including the above-described patent literature, because searching of content is carried out based on a single keyword selected by the user out of a plurality of keywords extracted from the content in use by the user, a wide search result in a range not intended by the user may be output. Meanwhile, in accordance with the embodiments, it is configured to carry out the search of content by adding, to a user-selected keyword out of a plurality of keywords extracted from the content (web page) in use (being browsed) by the user, at least one of other keywords excluding the user-selected keyword out of the extracted keywords. This provides an advantageous effect that search results that are better suited for user needs can be obtained (in other words, content similar to the content in use by the user can be searched).

While the exemplary embodiments have been explained in the foregoing, embodiments are not restricted to the above-described embodiments.

While a system that searches information over the Internet connected for communication has been explained in the foregoing embodiments, the embodiments other than that can be implemented, for example, in an information search system within a network such as a local area network (LAN) for a school, a company, and such, or a system that searches desired information from one or more external storage devices connected with a single information processing terminal.

While it has been explained that the keyword display screen S1 is displayed by the user performing a given keyword function calling operation (selection operation of the dedicated icon K) whenever necessary in the foregoing embodiments, it can be configured, other than that, for example, to display the keyword display screen S1 constantly.

While it has been explained that the dedicated icon “keyword” K in a taskbar is selected as a way to display the keyword display screen S1 in the foregoing embodiments, it can be configured, other than that, for example, to be realized by a plug-in of a web browser and that the keyword display screen S1 can be displayed when a dedicated button icon included in a web browser screen BS is selected.

In the foregoing embodiments, the display device 15 is used as a measure to notify the user of keywords, and a selection operation on a display screen is used as a measure to select a keyword. However, other than those, the keywords may be notified by other notifying measures such as a voice sound, and other selecting measures such as voice input can be adopted as a measure to select a keyword.

In the above-described embodiments, while a stationary PC used by the user has been explained as the information processor 1, the embodiments are not limited to this, and they can be applied to other information processors having a function to process information. Specifically, for example, the embodiments can be applied to user-portable information processors (e.g., a laptop PC, a cellular telephone, a personal digital assistance), home appliances having a function to process information (e.g., a television, a refrigerator, a microwave oven), or car navigation devices mounted on automobiles, for example.

The various types of programs executed in the information processor 1 of the above-described embodiments may be provided, other than being pre-installed in the information processor 1, by being stored in a computer readable storage medium, or may be provided or distributed via a network such as the Internet, in a file of an installable form or an executable form.

While it has been explained that the functional configuration illustrated in FIG. 3 is realized by the information processor 1 in the foregoing embodiments, is the embodiments are not limited to this. It is possible that a functional configuration other than the functional portions of requesting the processes of the web browser module 101, the keyword display module 108, the search result display module 112, and such depicted in FIG. 3, and receiving and displaying a processing result can be realized by one or more servers connected to a network such as the Internet N.

Furthermore, the appearance configuration, the hardware configuration, the software configuration and processing procedures, and the types of content, for example, of the information processing system and the information processor of the above-described embodiments have been presented byway of example only, and the present embodiments are not unduly restricted by those.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system, comprising:
a storage module configured to store content;
an extractor configured to extract a plurality of keywords acquired from the storage module, the keywords being related to content in use by a user;
a notifier configured to notify the user of the keywords extracted by the extractor; and
a search module configured to add at least one of the extracted keywords to a selected keyword selected by the user from among the notified keywords, and to carry out a search of content based on the added and selected keywords.

2. The information processing system of claim 1, wherein the search module is configured to search by adding, to the selected keyword, at least one other distinguishing keyword, excluding the selected keyword, from among the extracted keywords.

3. The information processing system of claim 1, further comprising an input module configured to input an instruction operation of a user instructing the notifier to make the notification, wherein
the notifier is configured to make the notification when the instruction operation is input to the input module.

4. The information processing system of claim 1, further comprising a search result notifier configured to notify the user of search results of the search module.

5. The information processing system of claim 4, further comprising a content reproducer configured to acquire content selected by a user from among the notified search results, thereby making the content available for use by the user.

6. The information processing system of claim 2, further comprising:
a search result notifier configured to notify the user of search results by the search module;
a selector configured to allow a user to select desired content from the notified search results; and
an acquiring module configured to acquire the selected content, wherein
the extractor is configured to extract at least one keyword related to the acquired content, and
the search module is configured to search by further adding the extracted at least one keyword to the selected keyword and the other distinguishing keywords.

7. The information processing system of claim 5, further comprising an information processor configured for use by a user, wherein the information processor comprises the notifier, the input module, the search result notifier, and the content reproducer.

8. An information processor comprising:
an extractor configured to extract a plurality of keywords related to content in use by a user;
a notifier configured to notify the user of the extracted keywords; and
a search module configured to add at least one of the extracted keywords to a selected keyword selected by the user from among the notified keywords, and to carry out a search of content based on added and selected keyword.

9. The information processor of claim 8, wherein the search module is configured to search by adding, to the selected keyword, at least one other distinguishing keyword, excluding the selected keyword, from among the extracted keywords.

10. The information processor of claim 8, further comprising an input module configured to input an instruction operation of a user instructing the notifier to make the notification, wherein
the notifier is configured to make the notification when the instruction operation is input to the input module.

11. The information processor of claim 8, further comprising a search result notifier configured to notify the user of search results of the search module.

12. The information processor of claim 11, further comprising a content reproducer configured to acquire content selected by a user from among the search result notified by the search result notifier, thereby making the content available for use by the user.

13. The information processor of claim 9, further comprising:
a search result notifier configured to notify the user of search results by the search module;
a selector configured for a user to select desired content out of the search results notified by the search result notifier; and
an acquiring module configured to acquire the selected content, wherein
the extractor is configured to extract at least one keyword related to the acquired content, and
the search module is configured to search by further adding the extracted at least one keyword to the selected keyword and the at least one other distinguishing keywords.

14. A computer program product having a non-transitory computer readable medium including programmed instructions, wherein the instructions, when executed by a computer, cause the computer to perform:
extracting a plurality of keywords related to content in use by a user;
notifying the user of the extracted keywords; and
adding the extracted keywords to a selected keyword selected by the user from among the notified keywords, and to carry out a search of content based on the added and selected keywords.
